(19) United States
(12) Patent Application Publication
(10) Pub. No.: US 2007/0147070 A1
(43) Pub. Date: Jun. 28, 2007

(54) Backlight module having light guide plate with diffusion pattern thereon and liquid crystal display having same

(75) Inventors: Kun-Hsien Yang, Miao-Li (TW); An Shih, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/642,073

(22) Filed: Dec. 20, 2006

(30) Foreign Application Priority Data
Dec. 23, 2005 (TW) 94146353

(51) Int. Cl. F21V 7/04

(52) U.S. Cl. 362/600

(57) ABSTRACT

An exemplary backlight module (11) includes a light guide plate (12), a reflector (18), and a light emitting diode unit (142). The light guide plate includes a light incident surface (122) and a diffusion pattern (126) located on the light incident surface. The reflector is positioned at a side of the light guide plate corresponding to the light incident surface, and has a reflection pattern (184) thereon. The light emitting diode unit is between the light incident surface and the reflector.

### FIELD OF THE INVENTION

The present invention relates to backlight modules such as those used in liquid crystal displays (LCDs), and more particularly to a backlight module having a light guide plate which has a diffusion pattern formed thereon.

### GENERAL BACKGROUND

Liquid crystal displays are commonly used as displays for compact electronic apparatuses, because they not only provide good quality images with little power but are also very thin. The liquid crystal in a liquid crystal display does not emit any light itself. The liquid crystal has to be lit by a light source to clearly and sharply display text and images. Thus, a backlight module is generally needed for a liquid crystal display.

Referring to FIG. 12, a typical backlight module 88 includes a light guide plate 880, a light source 882, and a reflector 884, arranged in that order from right to left. The backlight module 88 further includes a plastic frame 886 for receiving the light guide plate 880, the light source 882, and the reflector 884. The reflector 884 has a planar inner surface 885 facing the light source 882. The light source 882 interposed between the light guide plate 880 and the reflector 884 includes a plurality of light emitting diode (LED) units 888. Each LED unit 888 includes a red LED 888a, a green LED 888b, and a blue LED 888c, and each LED 888a/888b/888c emits light of a respective primary color.

In operation, light emitted requires mixing since each LED 888a/888b/888c emits a different color of light. Mixing generally occurs in a space that ranges from where the light is emitted from the LEDs 888a, 888b, and 888c to where the light reaches the light guide plate 880, thus obtaining white light. However, the mixing space for the light is limited by size of the plastic frame 886, and the mixed light is therefore liable to appear a little yellow or blue, instead of being pure white. This may result in an uneven color balance of light output from the backlight module 88. In order to obtain pure white light, the size of the plastic frame 886 needs to be large, requiring a correspondingly large increase in size of the backlight module 88. This makes the backlight module 88 unsuitable for certain compact and small-scale applications.

What is needed, therefore, is a backlight module that can overcome the above-described deficiencies. What is also needed is a liquid crystal display employing such a backlight module.

### SUMMARY

In one preferred embodiment, a backlight module includes a light guide plate, a reflector, and a light emitting diode unit. The light guide plate includes a light incident surface and a diffusion pattern located on the light incident surface. The reflector is positioned at a side of the light guide plate corresponding to the light incident surface, and has a reflection pattern defined thereon. The light emitting diode unit is between the light incident surface and the reflector.

Other aspects, advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of at least one embodiment of the present invention. In the drawings, like reference numerals designate corresponding parts throughout various views, and all the views are schematic.

FIG. 1 is an exploded, side view of a liquid crystal display according to a first embodiment of the present invention, the liquid crystal display including a backlight module, the backlight module including a plurality of diffusion particles outwardly extending from a light incident surface of a light guide plate thereof.

FIG. 2 is a top-down plan view of the backlight module of the liquid crystal display of FIG. 1.

FIG. 3 is a left side plan view of part of the light guide plate of the backlight module of the liquid crystal display of the first embodiment, shown when the light guide plate is oriented vertically, and showing diffusion particles on the light incident surface.

FIG. 4 is similar to FIG. 3, but showing a corresponding view in the case of a liquid crystal display according to a second embodiment of the present invention.

FIG. 5 is similar to FIG. 3, but showing a corresponding view in the case of a liquid crystal display according to a third embodiment of the present invention.

FIG. 6 is similar to FIG. 3, but showing a corresponding view in the case of a liquid crystal display according to a fourth embodiment of the present invention.

FIG. 7 is a top-down plan view of a backlight module according to a fifth embodiment of the present invention, the backlight module including a plurality of diffusion particles inwardly extending from a light incident surface of a light guide plate thereof.

FIG. 8 is a left side plan view of part of the light guide plate of the backlight module of the fifth embodiment, shown when the light guide plate is oriented vertically, and showing diffusion particles at the light incident surface.

FIG. 9 is similar to FIG. 8, but showing a corresponding view in the case of a backlight module according to a sixth embodiment of the present invention.

FIG. 10 is similar to FIG. 8, but showing a corresponding view in the case of a backlight module according to a seventh embodiment of the present invention.

FIG. 11 is similar to FIG. 8, but showing a corresponding view in the case of a backlight module according to an eighth embodiment of the present invention.

FIG. 12 is a top-down plan view of a conventional backlight module.

### DETAILED DESCRIPTION OF PREFERRED EMBODIMENTS

Reference will now be made to the drawings to describe the preferred embodiments in detail.

Referring to FIG. 1, a liquid crystal display 1 according to a first embodiment of the present invention is shown. The liquid crystal display 1 includes a liquid crystal panel 15, and a backlight module 11 adjacent to the liquid crystal panel 15.

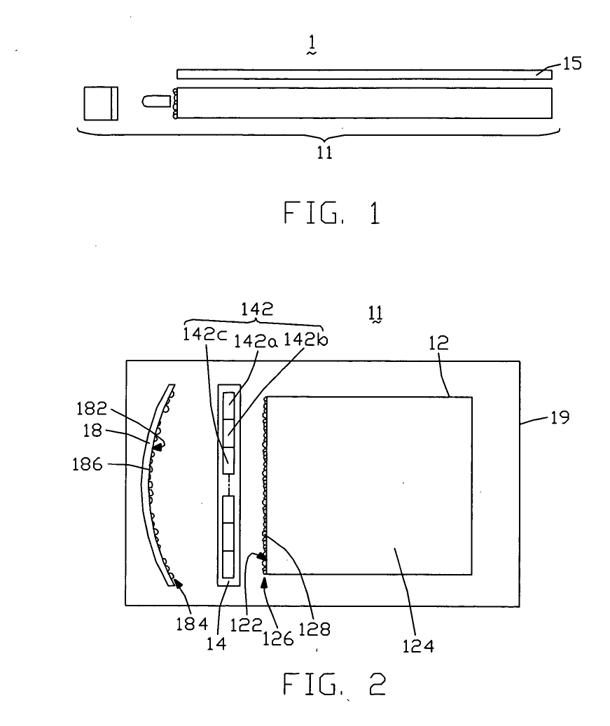

Referring to FIG. 2, the backlight module 11 includes a light guide plate 12, a light source 14, and a reflector 18, arranged in that order from right to left. The backlight module 11 further includes a frame 19 for receiving the light guide plate 12, the light source 14, and the reflector 18. In the illustrated embodiment, the frame 19 is made from plastic.

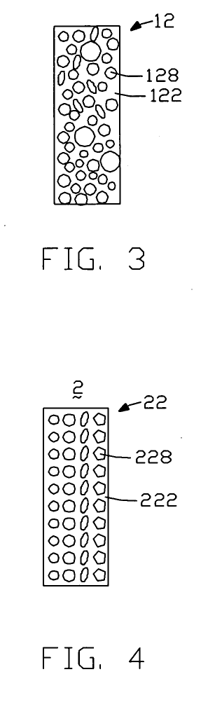

The light guide plate 12 includes a light incident surface 122, and a light emission surface 124 connected with the light incident surface 122. A diffusion pattern 126 is formed on the light incident surface. The diffusion pattern 126 includes a plurality of diffusion particles 128 outwardly extending from the light incident surface 122. Referring to FIG. 3, the diffusion particles 128 have many kinds of shapes and sizes, and are irregularly arranged. In the illustrated embodiment, the diffusion particles 128 are curved. For example, the diffusion particles 128 may be hemispherical, sub-hemispherical, semicylindrical, or sub-semicylindrical. The diffusion particles 128 can refract and diffuse light incident thereon. The light guide plate 12 together with the diffusion particles 128 can be made from polycarbonate (PC) or polymethyl methacrylate (PMMA), and can be manufactured using an injection molding method.

The light source 14 interposed between the light guide plate 12 and the reflector 18 includes a plurality of LED units 142. Each LED unit 142 includes a red LED 142a, a green LED 142b, and a blue LED 142c. Light is emitted from each LED 142a/142b/142c over a certain range of angles of divergence, which is hereafter referred to as a spread angle. When each LED 142a/142b/142c is viewed from above, the spread angle is generally in the range from 30 to 130 degrees, as measured from a front face of the LED 142a/142b/142c. Each LED 142a/142b/142c is arranged so that its spread angle expands toward the reflector 18. The reflector 18 includes an inner surface 182 facing the light source 14, and a reflection pattern 184 formed on the inner surface 182. The reflection pattern 184 includes a plurality of reflective protrusions 186 outwardly extending from the inner surface 182. The reflective protrusions 186 have many kinds of shapes and sizes. In the illustrated embodiment the reflective protrusions 186 are curved. For example, the reflective protrusions 186 may be hemispherical, sub-hemispherical, semicylindrical, or sub-semicylindrical. The reflective protrusions 186 are irregularly arranged.

In operation, light of a respective primary color emits from each of the LEDs 142a/142b/142c toward the reflector 18. Light incident on the reflective protrusions 186 on the inner surface 182 of the reflector 18 is reflected in all directions, and then reaches the light incident surface 122 of the light guide plate 12. A mixing process of light of different colors occurs since each LED 142a/142b/142c emits light of a different color. Because the light is reflected by the reflective protrusions 186 in all directions, most of the red, green and blue (RGB) light is mixed to form white light before it reaches the light guide plate 12. When the unmixed red, green and blue light is incident on the light incident surface 122 of the light guide plate 12, it is refracted and diffused by the diffusion particles 128 thereon. As a result, the diffused red, green, blue light is fully mixed to pure white light in the light guide plate 12, thus emitting pure white light for the backlight module 11. This is achieved without requiring a large-sized backlight module. This optimizes optical performance of the associated liquid crystal display 1, with the liquid crystal display 1 being able to be used in compact and small-scale applications.

Referring to FIG. 4, a liquid crystal display 2 according to a second embodiment of the present invention is similar to the liquid crystal display 1. However, a plurality of diffusion particles 228 outwardly extend from a light incident surface 222 of a light guide plate 22 of the liquid crystal display 2 at regular intervals, and have many kinds of shapes and sizes.

Referring to FIG. 5, a liquid crystal display 3 according to a third embodiment of the present invention is similar to the liquid crystal display 1. However, a plurality of diffusion particles 328 outwardly extend from a light incident surface 322 of a light guide plate 32 of the liquid crystal display 3 at regular intervals, with the diffusion particles 386 having essentially identical shapes and sizes.

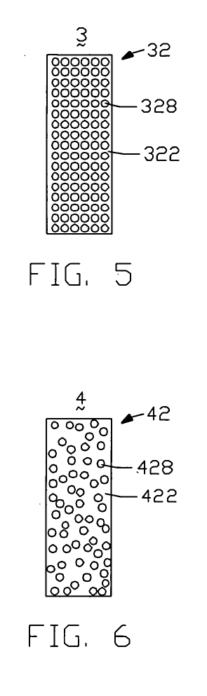

Referring to FIG. 6, a liquid crystal display 4 according to a fourth embodiment of the present invention is similar to the liquid crystal display 1. However, a plurality of diffusion particles 428 outwardly extend irregularly from a light incident surface 422 of a light guide plate 42 of the liquid crystal display 4, with the diffusion particles 486 having essentially identical shapes and sizes.

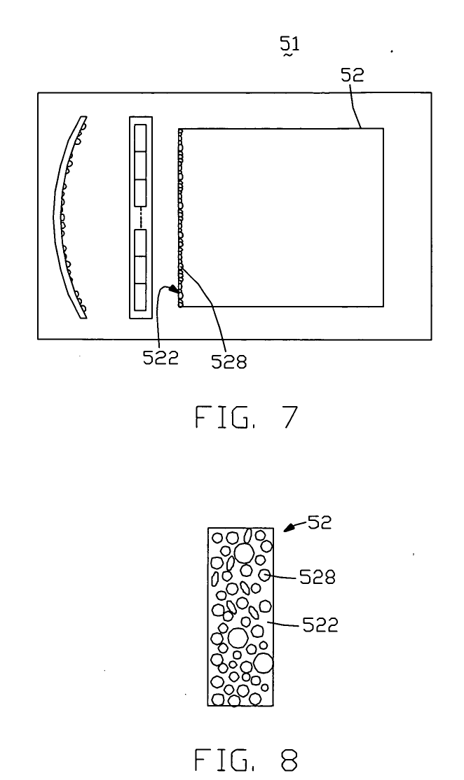

Referring to FIG. 7 and FIG. 8, a backlight module 51 according to a fifth embodiment of the present invention is similar to the backlight module 11 described above. However, a plurality of diffusion particles 528 inwardly extend from a light incident surface 522 of a light guide plate 52 of the backlight module 51 at irregular intervals, and have many kinds of shapes and sizes. That is, the diffusion particles 528 are formed in depressions in the light incident surface 522.

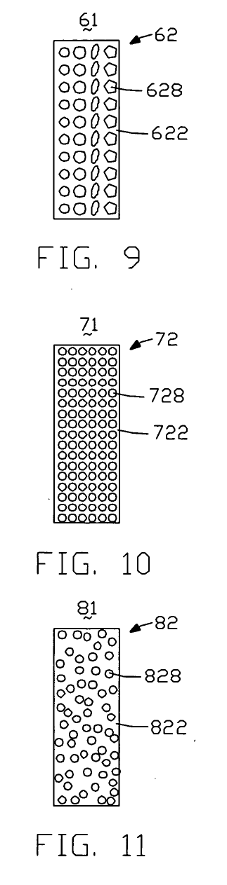

Referring to FIG. 9, a backlight module 61 according to a sixth embodiment of the present invention is similar to the backlight module 51 described above. However, a plurality of diffusion particles 628 outwardly extend regularly from a light incident surface 622 of a light guide plate 62 of the backlight module 61, and are of many different shapes and sizes.

Referring to FIG. 10, a backlight module 71 according to a seventh embodiment of the present invention is similar to the backlight module 51 described above. However, a plurality of diffusion particles 728 outwardly extend regularly from a light incident surface 722 of a light guide plate 72 of the backlight module 71, with the diffusion particles 728 having essentially identical shapes and sizes.

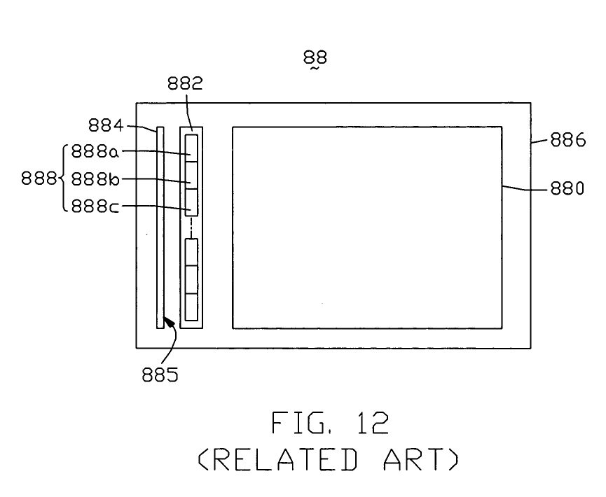

Referring to FIG. 11, a backlight module 81 according to an eighth embodiment of the present invention is similar to the backlight module 51 described above. However, a plurality of diffusion particles 828 outwardly extend at irregular intervals from a light incident surface 822 of a light guide plate 82 of the backlight module 81, with the diffusion particles 828 having essentially identical shapes and sizes.

Other alternative embodiments may include the following. In one example, each LED 142a/142b/142c can instead be another kind of point illuminator that has a certain spread angle, such as, for example, filament-type light bulbs.

It is believed that the present embodiments and their advantages will be understood from the foregoing description, and it will be apparent that various changes may be made thereto without departing from the spirit or scope of the invention or sacrificing all of its material advantages, the examples hereinbefore described merely being preferred or exemplary embodiments of the invention.

What is claimed is:

1. A backlight module comprising:
a light guide plate comprising:
a light incident surface; and
a diffusion pattern formed at the light incident surface;
a reflector positioned at a side of the light guide plate corresponding to the light incident surface, the reflector comprising a reflection pattern thereon; and
a light emitting diode unit between the light incident surface and the reflector.

2. The backlight module in claim 1, wherein the light emitting diode unit comprises a red light emitting diode, a green light emitting diode, and a blue light emitting diode.

3. The backlight module in claim 2, wherein light is emitted from each light emitting diode over a certain range of angles of divergence, the angles of divergence define a spread angle, and the light emitting diode unit is arranged in a manner such that the spread angles of the light emitting diodes expand toward the reflector.

4. The backlight module in claim 3, wherein when the illuminator is viewed from above, the spread angle of each light emitting diode is in the range from 30 to 130 degrees as measured from a front face of each light emitting diode.

5. The backlight module in claim 1, wherein the diffusion pattern comprises a plurality of diffusion particles.

6. The backlight module in claim 5, wherein the diffusion particles are arranged in a manner selected from the group consisting of the diffusion particles outwardly extending from the light incident surface and inwardly extending from the light incident surface.

7. The backlight module in claim 6, wherein the diffusion particles extend at irregular intervals.

8. The backlight module in claim 6, wherein the diffusion particles extend at regular intervals.

9. The backlight module in claim 6, wherein the diffusion particles have different shapes and different sizes.

10. The backlight module in claim 6, wherein the diffusion particles have essentially the same shape and the same size.

11. The backlight module in claim 1, wherein the reflection pattern comprises a plurality of reflective protrusions.

12. The backlight module in claim 11, wherein the reflector further comprises an inner surface facing the light emitting diode unit.

13. The backlight module in claim 12, wherein the reflective protrusions protrusively extend from the inner surface.

14. The backlight module in claim 13, wherein the reflective protrusions extend at irregular intervals.

15. The backlight module in claim 13, wherein the reflective protrusions have different shapes and different sizes.

16. A liquid crystal display comprising:
a liquid crystal panel; and
a backlight module at a side of the light guide plate corresponding to the liquid crystal panel, the backlight module comprising:
a light guide plate comprising:
a light incident surface; and
a diffusion pattern located at the light incident surface;
a reflector positioned adjacent to the light incident surface, the reflector comprising a reflection pattern thereon; and
a light emitting diode unit between the light incident surface and the reflector.

17. The liquid crystal display in claim 16, wherein the diffusion pattern comprises a plurality of diffusion particles.

18. The liquid crystal display in claim 17, wherein the diffusion particles are arranged in a manner selected from the group consisting of the diffusion particles outwardly extending from the light incident surface and inwardly extending from the light incident surface.

19. The liquid crystal display in claim 18, wherein the diffusion particles extend at irregular or regular intervals.

20. A backlight module comprising:
a light guide plate comprising:
a light incident surface; and
a reflector positioned at a side of the light guide plate corresponding to the light incident surface, the reflector comprising a reflection pattern thereon; and
a light emitting diode unit extending along a lengthwise direction thereof and between the light incident surface and the reflector, said light emitting diode unit defining two opposite longitudinal ends; wherein
the reflector defines two opposite ends, along said lengthwise direction, which is bowed toward the corresponding longitudinal ends, respectively.
